(19) United States
(12) Patent Application Publication
(10) Pub. No.: US 2013/0300987 A1
(43) Pub. Date: Nov. 14, 2013

(54) EYE-FRIENDLY CALCULATOR

(71) Applicant: Ming-Chan Ho, Taipei County (TW)

(72) Inventor: Ming-Chan Ho, Taipei County (TW)

(21) Appl. No.: 13/468,032

(22) Filed: May 10, 2012

(51) Int. Cl. G02F 1/1335

(52) U.S. Cl. 349/106

(57) ABSTRACT

An eye-friendly calculator includes a main body being provided on a front side with a display zone consisting of a liquid crystal display (LCD) panel for displaying numerals and symbols; and a display-zone cover being correspondingly provided on the front side of the main body to cover the display zone. The display-zone cover is provided with a transparent window portion, which is made of a light-transmitting and tinted material and located corresponding to the LCD panel of the display zone. The transparent and tinted window portion has an eye-friendly color, which also filters out traces of LCD font that appear on the LCD panel at blank positions and overlapped images of displayed digits or symbols visible when viewing from an angular position relative to the calculator, so that a user can comfortably work on the calculator over a long time without having weary eyes easily.

### BACKGROUND OF THE INVENTION

1. Field of the Invention

The present invention relates to an eye-friendly calculator, and more particularly to an electronic calculator having electronic circuits for performing mathematical calculation and an eye-friendly display zone.

2. Description of the Prior Arts

Most of the currently available electronic calculators include a long strip of liquid crystal display (LCD) panel, which is correspondingly located within a window portion provided on a case of the calculator for showing numerals or symbols input by a user via a plurality of keys on the case. The window portion has a transparent plastic sheet provided thereat to protect the LCD panel against external environment.

Frequently, traces of LCD font will appear on a background of the LCD panel at positions without displaying the input digits or symbols, and overlapped images of displayed digits or symbols are visible when viewing the LCD panel from an angular position relative to the calculator. These undesirable traces and/or images not only interfere with the user's vision, but also cause discomfort and tiredness to the user's eyes. Further, the numerals and symbols shown in the LCD panel are usually black or dark grey in color, and there is only a low contrast between these displayed numerals and symbols and the background of the LCD panel, which also tends to bring weary eyes to the user.

It is therefore tried by the inventor to develop an eye-friendly calculator to overcome the above-mentioned problems with the prior art calculators.

### SUMMARY OF THE INVENTION

A primary object of the present invention is to provide an eye-friendly calculator to overcome drawbacks in the prior art calculators.

To achieve the above and other objects, the eye-friendly calculator according to the present invention includes a main body being provided on a front side with a plurality of keys and a display zone consisting of a liquid crystal display (LCD) panel for displaying numerals and symbols; and a display-zone cover being correspondingly provided on the front side of the main body to cover the display zone. The display-zone cover is provided with a transparent window portion, which is made of a light-transmitting and tinted material and located corresponding to the LCD panel in the display zone. The transparent and tinted window portion has an eye-friendly color, such as a warm orange color or a light green color.

When using the eye-friendly calculator of the present invention, since the transparent window portion on the display-zone cover is tinted to show an eye-friendly color, such as orange or green color, an eye-friendly visual effect is created due to a high contrast between the color of the transparent window portion and the numerals and symbols shown on the LCD panel. Under this circumstance, the user would not have weary eyes even if he or she has been working on the calculator over a long period of time. Therefore, for users who often have to work on a calculator for a long time, the eye-friendly calculator of the present invention provides good eye protection to them. Moreover, since the transparent window portion is tinted to show some specific eye-friendly color, it is able to filter out traces of LCD font that appear on the background of the LCD panel at positions without displaying the input digits or symbols, and overlapped images of displayed digits or symbols visible when viewing from an angular position relative to the calculator. Therefore, the user working on the calculator would not be interfered by these undesirable traces and images and can view the LCD panel comfortably.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an eye-friendly calculator according to an embodiment of the present invention; and

FIG. 2 is an exploded view of FIG. 1.

### DETAILED DESCRIPTION OF THE PREFERRED EMBODIMENTS

The present invention will now be described with a preferred embodiment thereof with reference to the accompanying drawings. It is understood the accompanying drawings are illustrated only for assisting in describing the present invention and is not necessarily in compliance with the exact or precise size proportion and part arrangement of a real product manufactured through implementing the present invention. Therefore, the size proportion and part arrangement shown in the accompanying drawings are not intended to limit the present invention, which is intended to be limited only by the appended claims.

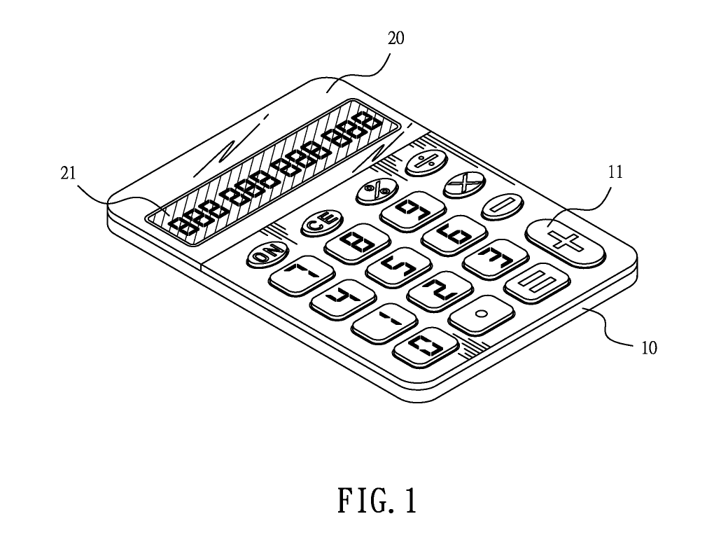

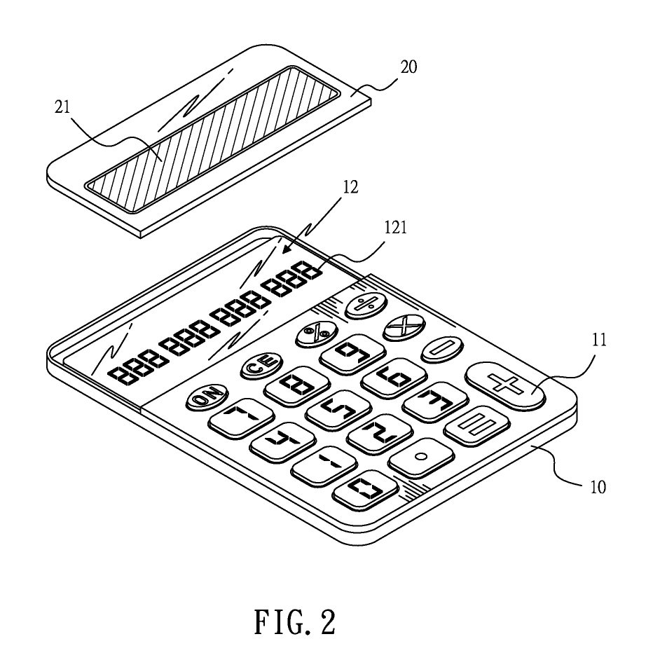

Please refer to FIGS. 1 and 2. An eye-friendly calculator according to a preferred embodiment of the present invention includes a main body 10 and a display-zone cover 20.

The main body 10 is provided on a front side with a plurality of keys 11, with which a user can operate to input numerals and symbols for performing mathematical calculation; and a display zone 12 consisting of a liquid crystal display (LCD) panel 121 for displaying the input numerals and symbols.

The display-zone cover 20 is correspondingly provided on the front side of the main body 10 to cover the display zone 12, and includes a transparent window portion 21. The transparent window portion 21 can be formed with a light-transmitting and tinted plastic material, and is located corresponding to the LCD panel 121. Preferably, the tinted plastic material for forming the transparent window portion 21 has an eye-friendly color, such as a warm orange color or a light green color, so that the user can comfortably view the numerals and symbols shown on the LCD panel 121.

When using the eye-friendly calculator of the present invention, since the transparent window portion 21 on the display-zone cover 20 is tinted to show an eye-friendly color, such as orange or green color, an eye-friendly visual effect is created due to a high contrast between the color of the transparent window portion 21 and the numerals and symbols shown on the LCD panel 121. Under this circumstance, the user would not have weary eyes even if he or she has been working on the calculator of the present invention over a long period of time. Therefore, for users who often have to work on a calculator for a long time, the eye-friendly calculator of the present invention provides good eye protection to them. Moreover, since the transparent window portion 21 is tinted to show some specific eye-friendly color, it is able to filter out the traces of LCD font that appear on the background of the LCD panel 121 at positions without displaying the input digits or symbols, and overlapped images of displayed digits or symbols visible when viewing from an angular position relative to the calculator. Therefore, the user working on the calculator of the present invention would not be interfered by these undesirable traces and images and can view the LCD panel 121 comfortably.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An eye-friendly calculator, comprising:
a main body being provided on a front side with a plurality of keys and a display zone consisting of a liquid crystal display (LCD) panel for displaying numerals and symbols input by a user via the keys; and
a display-zone cover being correspondingly provided on the front side of the main body to cover the display zone; the display-zone cover being provided with a transparent window portion, which is made of a light-transmitting and tinted material and located corresponding to the LCD panel of the display zone.

2. The eye-friendly calculator as claimed in claim 1, wherein the transparent window portion of the display-zone cover has a warm orange color.

3. The eye-friendly calculator as claimed in claim 1, wherein the transparent window portion of the display-zone cover has a light green color.
